(19) United States
(12) Patent Application Publication
(10) Pub. No.: US 2006/0016458 A1
(43) Pub. Date: Jan. 26, 2006

(54) Reduced pressure irradiation processing method and apparatus

(76) Inventors: Richard Novak, Plymouth, MN (US); Robert S. Monko, Orefield, PA (US); Glenn Marshall, Northampton, PA (US)

Correspondence Address: COZEN O'CONNOR, P.C., 1900 MARKET STREET, PHILADELPHIA, PA, 19103-3508, US

(21) Appl. No.: 11/178,923

(22) Filed: Jul. 11, 2005

Related U.S. Application Data
(60) Provisional application No. 60/586,773, filed on Jul. 9, 2004.

(51) Int. Cl. B08B 3/00

(52) U.S. Cl. 134/1; 134/61

(57) ABSTRACT

A system and method for processing substrates, such as porous low-K semiconductor wafers, using ultraviolet (UV) radiation is disclosed. The substrates are first cleaned in a wet processing module and then dried in a UV module under reduced pressure and at a temperature below 100 C., preferably at or below 80 C. A robot module transfers the substrates from the wet processing module to the UV module. The UV module can include a pulse xenon excimer lamp providing incoherent vacuum ultraviolet (VUV) radiation at 172 nm.

### CROSS-REFERENCE TO RELATED APPLICATIONS

The present application claims the benefit of U.S. Provisional Application Ser. No. 60/586,773, filed Jul. 9, 2004, the entirety of which is incorporated herein by reference.

### BACKGROUND OF THE INVENTION

The present invention relates generally to systems and methods for processing substrates, especially systems and methods for cleaning and/or drying silicon wafer or photomask substrates. The invention also relates to single wafer cleaning and drying methods and apparatus.

The use of ultraviolet radiation during various substrate processing steps, such as the removal of organic compounds or cleaning, is known. However, existing systems are less than optimal in that the processing takes too long or does not achieve optimal end result requirements.

Single wafer wet processing systems have become available and are being used commercially, among which are the “Goldfinger” single wafer megasonic cleaning system, “Sahara” single wafer drying system, “Rotagoni,” and “Oasis” single wafer spin drying systems which result in wafers previously considered to be sufficiently dry for further processing. Such single wafer wet processing systems are described in U.S. Pat. Nos. 6,754,980; 6,732,749; 6,684,891; 6,681,782; 6,463,938; 6,295,999; 6,140,744; 6,122,837; 6,039,059; 5,556,479; 5,556,479; 5,286,657; 5,090,432; all assigned or previously to Verteq, Inc., Goldfinger LLC, Akrion LLC, and IMEC; and in U.S. patent Publication US 2002/0029788 A1; and U.S. Pat. No. 6,843,855 ('855), assigned to Applied Materials, Inc., all of which are hereby incorporated by reference in their entireties.

The aforementioned '855 patent discloses the fact that conventional SiO₂ has a relative dielectric constant of roughly 4, but that the semiconductor industry has recently introduced dielectric materials having relative dielectric constants of less than 4, referred to as “low-K” materials, that many of such low-K materials rely on the inclusion of pores or voids to achieve their low-K properties, and that when liquids are used in a conventional wet cleaning and drying process, especially the aforementioned conventional single wafer wet processing systems, capillary forces draw the liquid into such pores or voids. The trapped liquids can be water, reagent, or other rinsing or cleaning fluids. Conventional spin dry, IPA spin dry, or other drying methods used in wet processing apparatus do not dry such trapped liquid(s).The solution proposed in the '855 patent was adding either a supercritical drying chamber or a low-pressure chamber and substrate transferring chamber to a conventional wet-cleaning chamber in order to dry the trapped fluid.

The '855 patent supercritical fluid drying chamber used, for example, carbon dioxide drying gas. The '855 low pressure drying chamber using temperatures of 100-200° C. and pressures below 10 Torr to dry such trapped fluid from low-K substrates which have been cleaned and dried in a wet process. There are several reasons why the use of supercritical fluid drying is undesirable, and there are also reasons why the use of 100-200° C. temperature in a low pressure drying chamber is undesirable, for example at such high temperatures sodium, lithium, potassium, and/or other ions can migrate. We have recognized a need to provide a drying system and method for low-K substrates which avoids supercritical fluids and also avoids heating to 100-200° C.

### SUMMARY OF THE INVENTION

This and other needs are met by the present invention which in one aspect is a method for cleaning a substrate comprising cleaning the substrate in a wet-cleaning module; drying the substrate in the wet-cleaning module; transferring the substrate from the wet-cleaning module to a UV module, the UV module having a source of UV radiation; and drying the substrate in the UV module using UV radiation at subatmospheric pressure and at a temperature below 100° C.; wherein the wet-cleaning module and the UV module are coupled to a substrate transferring module which transfers the substrate to and from the wet-cleaning module and the UV module.

The system aspect of the invention is an apparatus for cleaning a substrate comprising a UV module having a source of UV radiation; a wet-cleaning module having drying means; a substrate transferring module having means to transfer a cleaned substrate from the wet-cleaning module to the UV module; means to reduce pressure in the UV module; and a source of UV radiation in the UV module capable of drying the substrate at sub-atmospheric pressure and at a temperature below 100° C.

Preferably the temperature does not exceed 80° C. The invention is especially useful for hard to dry substrates such as certain reticles and especially low-K materials having pores. Preferably the drying in the UV module is carried out for 60 to 90 seconds, although longer and shorter drying times are certainly feasible.

The preferred source of UV radiation is a pulse xenon excimer lamp providing incoherent vacuum ultraviolet (VUV) radiation at 172 nm at a temperature not exceeding 80° C. without cooling. In some embodiments the source of UV radiation is a pulse xenon excimer lamp providing incoherent vacuum ultraviolet (VUV) radiation at 172 nm at a temperature not exceeding 80° C. without cooling. In other embodiments wherein the UV module comprises a VUV light box having three UV light sources and a reflector which providing incoherent VUV radiation at 172 nm in a nitrogen atmosphere and a VUV processing module having gas distribution manifolds, a vacuum manifold, and sensor ports.

Controllers and pressure valves can be used to control the subatmospheric pressure below 10 Torr.

The optional ultraviolet transmissive window is preferably made of fluorinated glass or sapphire. The UV light box may contain a reflector for providing uniform ultraviolet radiation transmission.

The controller may activates components for creating a cleaning gas atmosphere upon activating the components for reducing pressure, thereby backfilling the first module with cleaning gas as undesirable gases are removed.

The apparatus can include a source of inert gas is selected from the group consisting of nitrogen and argon, and can also include two or more of the UV modules.

The UV module can include a process chamber having means for supporting at least one substrate; means for reducing pressure within the process chamber below atmospheric pressure; a source of ultraviolet (UV) radiation for providing UV radiation to a substrate supported in the process chamber; optionally means for creating an inert gas atmosphere in the UV module; and optionally a UV transmissive window separating the process and the UV chamber(s).

A sensor for detecting intensity of ultraviolet radiation can be provided in the process chamber or in the UV chamber to ensure that the UV lamp is working properly. It is also preferable that the process chamber be capable of being sealed when a substrate is positioned therein. The means for supporting the at least one substrate can be adjustable in height and preferably supports the at least one substrate in a substantially horizontal orientation.

The UV module can be positioned above or below a wet processing module. The inert gas atmosphere in the UV module can be made of nitrogen and the cleaning gas atmosphere can comprise oxygen and/or ozone.

In another aspect, the invention is an apparatus for processing at least one substrate comprising: a first module having a substrate support; means for reducing pressure within the first module below atmospheric pressure; a source of a gas fluidly coupled to the first module; a UV module having a source of ultraviolet radiation for providing ultraviolet radiation to a substrate supported in the first module; a source of inert gas fluidly coupled to the UV module; and an ultraviolet transmissive window separating the first and second modules.

In yet another aspect, the invention is an apparatus for processing at least one substrate comprising: a first module having a substrate support; means for reducing pressure within the first module below atmospheric pressure; a source of a cleaning gas fluidly coupled to the first module; a second module having a source of ultraviolet radiation for providing ultraviolet radiation to the first module; and an ultraviolet transmissive window separating the first and second modules.

Still in another aspect, the invention is an apparatus for cleaning at least one substrate comprising: a hermetically sealable first module having a substrate support; means to reduce pressurize within the first module below atmospheric pressure; means to produce a gaseous atmosphere comprising at least one gas for processing a substrate in the first module; a second module having a wall in common with the first module; an ultraviolet transmissive window forming at least a portion of the common wall; a source of ultraviolet radiation positioned in the second module so as to emit ultraviolet radiation through the window and into the first module when activated; and means to produce a substantially inert gaseous atmosphere in the second module.

In a still further aspect, the invention is an apparatus for cleaning at least one substrate comprising: a hermetically sealable first chamber having a substrate support; means to reduce pressurize within the first chamber below atmospheric pressure; means to produce a gaseous atmosphere comprising at least one gas for processing a substrate in the first chamber; a source of ultraviolet radiation for providing ultraviolet radiation to a substrate positioned on the substrate support.

In a yet further aspect, the invention is an apparatus for providing ultraviolet radiation to at least one substrate comprising: a chamber containing a source of ultraviolet radiation; an ultraviolet transmissive window forming at least a portion of a wall of the chamber; and means to produce a substantially inert gaseous atmosphere in the chamber.

Another aspect of the invention is a method of cleaning at least one substrate comprising supporting the substrate in a first module; reducing pressure within the first module to a sub-atmospheric pressure; creating a cleaning gas atmosphere in the first module; and exposing the substrate(s) to ultraviolet radiation.

The UV module is preferably maintained at a slight vacuum to ensure fast drying times. The source of UV radiation preferably a UV lamp that produces UV radiation having a wavelength within a range of 100 to 300 nanometers, most preferably 172 nanometers. One suitable UV lamp is an Osram Xeradex® brand which emits incoherent vacuum ultraviolet (VUV) radiation at 172 nm without ever exceeding 80° C., without the need for water or other cooling. This type of VUV lamp also provides additional cleaning beyond that provided by a wet processing module, although it is still preferred to have a prior wet processing module as disclosed in the '855 patent and the other aforementioned patents. These VUV type lamps produce ozone and oxygen radicals to dry and clean low-K substrates better than achievable with wet processing systems alone.

Preferably, the ultraviolet radiation is created by a source of ultraviolet radiation such as a UV lamp positioned in a second module, the first and second modules being separated by an ultraviolet transmissive window through which the ultraviolet radiation passes. It is also preferable that an inert gas atmosphere, such as nitrogen or argon, be created in the second module. The second module can be maintained at atmospheric pressure. The substrate can be a semiconductor wafer or a reticle substrate.

It is further preferable that a ultraviolet transmissive window be provided and made of fluorinated glass or sapphire. Additionally, a reflector can be provided in the UV module for providing uniform ultraviolet radiation transmission. A controller can be provided that activates the means for creating a gas atmosphere in the process module upon activating the means for reducing pressure, thereby backfilling the process module with cleaning gas as undesirable gases are removed therefrom.

When the substrate is a photomask, the intensity of the ultraviolet radiation can be monitored and the distance between the substrate and the source of the ultraviolet radiation can be adjusted to a desired distance. The ultraviolet radiation most preferably has a wavelength of approximately 172 nanometers and the substrate can be supported in a substantially vertical or horizontal orientation. The cleaning gas atmosphere can comprise oxygen or nitrogen.

In another aspect, the invention is method of providing ultraviolet radiation to at least one substrate comprising: supporting a substrate in a first chamber; providing a second chamber adjacent to the first chamber, the second chamber containing a source of ultraviolet radiation and an ultraviolet transmissive window that forms at least a portion of a wall of the second chamber; providing a substantially inert gas atmosphere in the second chamber; activating the source of ultraviolet radiation so that the ultraviolet radiation is emitted through the window and into the first chamber, thereby exposing the substrate to the ultraviolet radiation.

### BRIEF DESCRIPTION OF THE DRAWING

FIG. 1 is a front perspective view of a substrate processing apparatus according to an embodiment of the present invention in an open position for receiving a substrate.

FIG. 2 is a rear perspective view of the substrate processing apparatus of FIG. 1.

FIG. 3 is a front perspective view of the UV chamber and substrate process chamber of the substrate processing apparatus of FIG. 1 with the UV light box housing removed.

FIG. 4 is a side cross sectional view of the UV chamber and substrate process chamber of the substrate processing apparatus of FIG. 1 in a closed position and supporting a substrate.

FIG. 5 is illustrates an embodiment of an apparatus which includes wet processing modules, UV drying modules, and a substrate transferring module.

### DESCRIPTION OF THE INVENTION

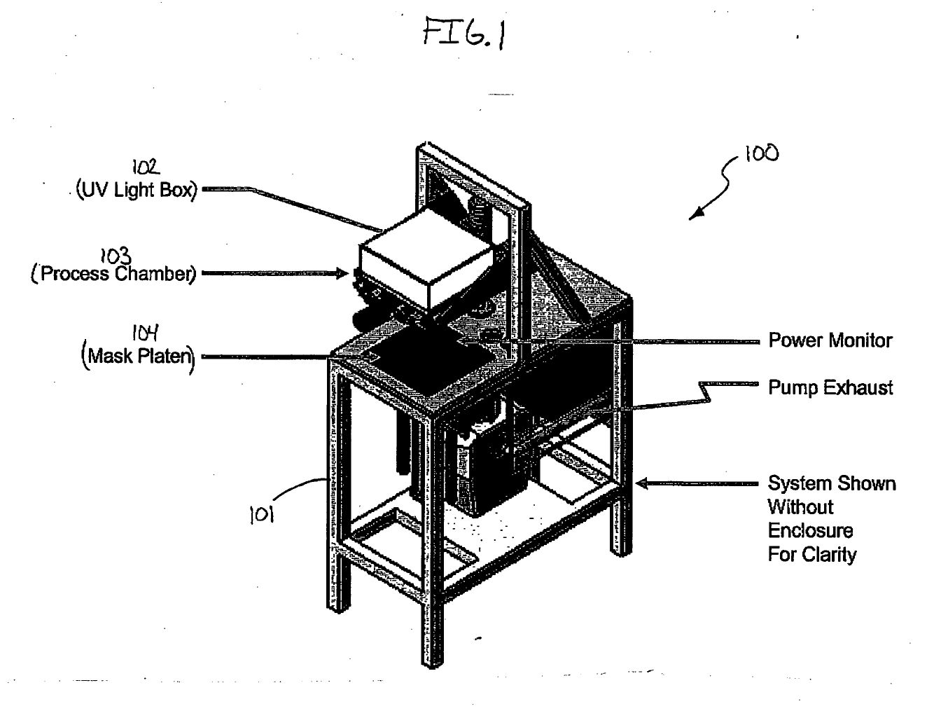

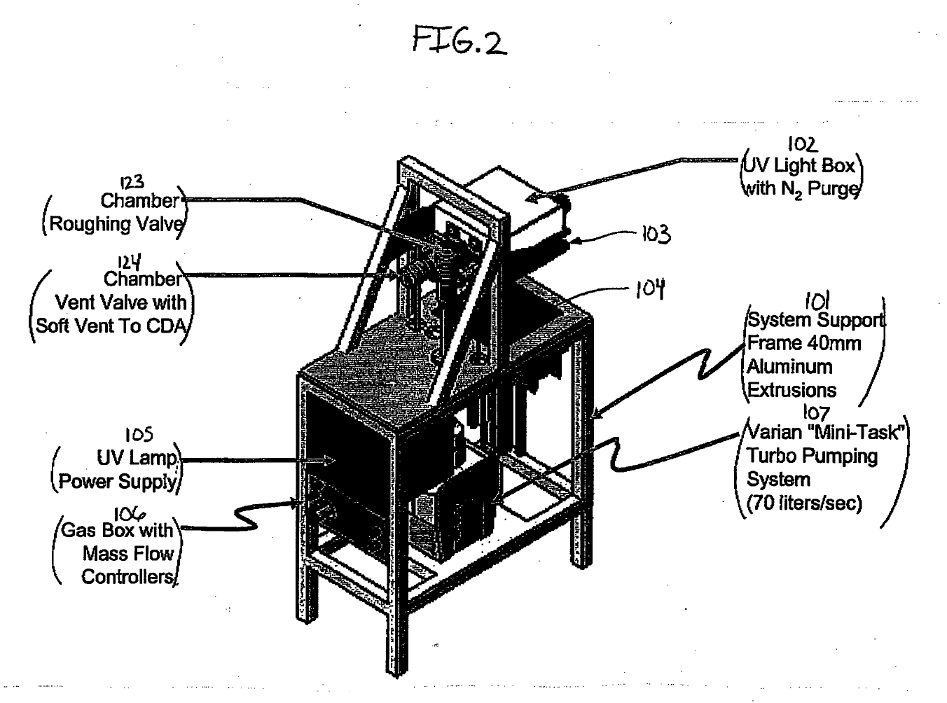

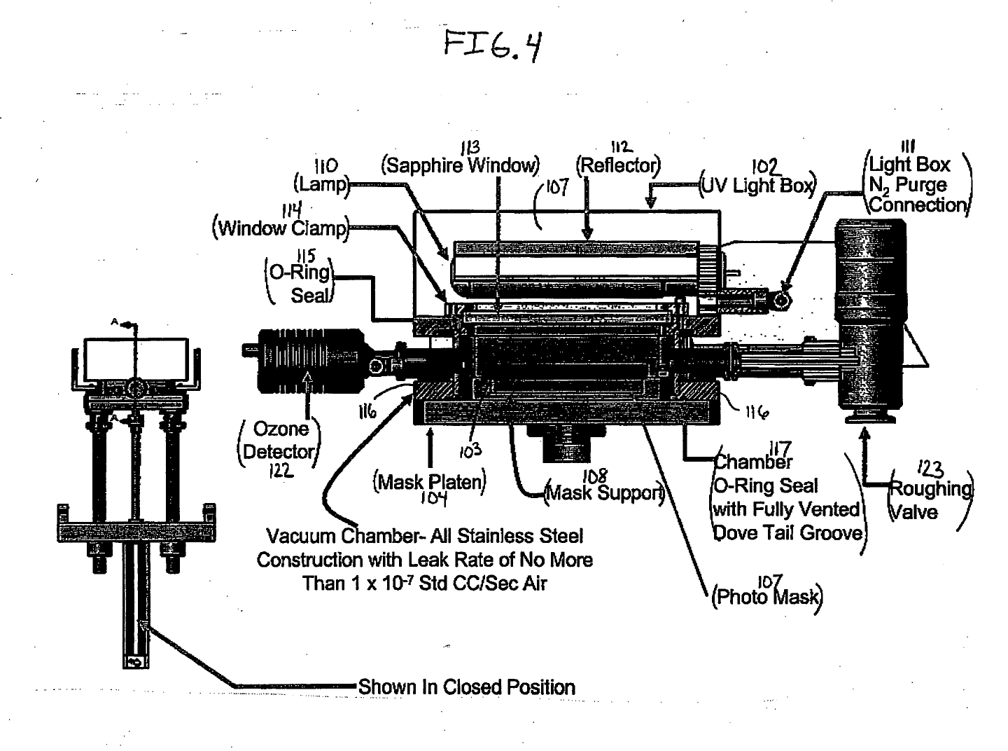

FIGS. 1 and 2 schematically illustrate a one UV drying module 100 embodiment of the present invention. The substrate process apparatus 100 comprises a support frame assembly 101 that supports the various components for operating the apparatus, including an ultraviolet (“UV”) light box 102, a substrate process chamber 103, a mask platen 104, an ultraviolet lamp power supply 105, a gas box 106 containing mass flow controllers, and a pumping system 109. Substrate process system 100 is a two chamber system for the purpose of irradiating photomask, reticle substrates, and semiconductor substrates with ultraviolet radiation in a reduced pressure environment for the purposes of removing contamination in the form of residual films and particles. Substrate process system 100 comprises a substrate process chamber 103 and a separate UV chamber 127 (shown in FIG. 4). The substrate process chamber 103 and the UV chamber 127 are substantially vertically aligned, wherein the UV chamber 127 is atop the process chamber 103.

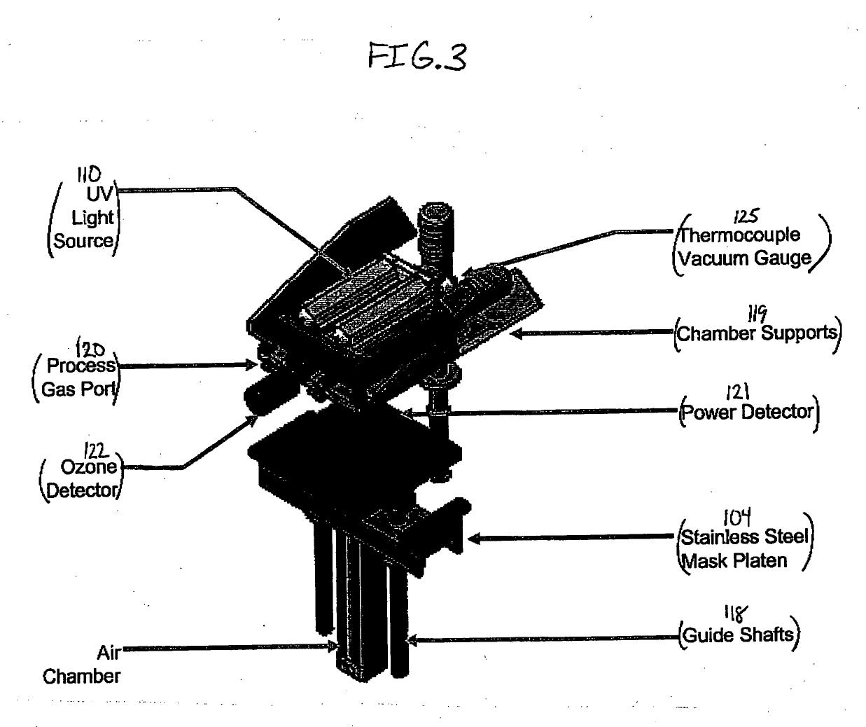

Referring to FIGS. 3 and 4, the UV light box 102 forms a UV chamber 127 that contains UV lamps 110 that are a source of UV radiation. Preferably, the UV lamp 110 creates UV radiation having a wavelength of approximately 172 nanometers. During operation, the UV chamber 127 is preferably maintained at atmospheric pressure and filled with nitrogen gas so as to form an inert nitrogen gas atmosphere. An inert gaseous atmosphere is maintained in the UV chamber 127 to minimize/reduce absorption of the UV radiation in this gas space. The nitrogen gas is supplied (and removed) via a purge connection 111 that is fluidly coupled to a source/reservoir of nitrogen gas (not shown). Alternatively, other inert gases may be used. Mass flow controllers, pumps, and valves can be incorporated as needed on the inert gas supply line in order to meet operability requirements.

Additionally, a faceted reflector 112 is shown in conjunction with the UV lamp 110 to provide a uniform UV radiation exposure to the surface of a substrate supported in the process chamber 103. Absorption of the UV radiation in the UV chamber would render this reflector useless, hence, the inert gaseous atmosphere in the UV chamber 127.

Process chamber 103 has an open and closed position. When in the open position, the mask platen 104 is in a lowered position away from the UV chamber 127 (as illustrated in FIG. 1). The mask platen 104 comprises a substrate/mask support 108 for supporting a substrate/photo mask 107 thereon. When in the open position, a substrate/photo mask 107 can be positioned in a substantially horizontal orientation atop the substrate/mask support 108. The mask platen 104 is then raised until it compresses the chamber O-ring seal 117 positioned in a fully vented dove tail groove, thereby contacting the side walls 116 of the process chamber 103 and forming a substantially sealed fit. The process chamber 103 is preferably all stainless steel and, when closed, has a leak rate no more than 1×10⁻⁷ Std CC/sec Air. Once closed and sealed, the process chamber 103 can be run at sub-atmospheric conditions by applying a vacuum force. Process gases, such as cleaning gases, can be supplied to the process chamber 103 via a gas port 120 (FIG. 3) that is fluidly coupled to the appropriate gas sources/reservoirs.

Referring solely to FIG. 3, the mask platen 104 is shown in the lowered position. Mask platen 104 can be raised through the use of a pneumatic lifter in combination with guide shafts 118. Alternatively, mask platen 104 can be maintained in a stationary position while the UV light box 102 (FIG. 1) and sidewalls 116 (FIG. 4) of process chamber are raised and/or lowered. Mask platen 104 is preferable made of stainless steel. Chamber supports 119 help support the chambers 103 in a stationary raised position. In yet another alternative embodiment, the process chamber 103 can comprise sealable openings that allow for the insertion and removal of a substrate/photo mask with and automated handling system.

Referring back to FIG. 4, positioned between the UV chamber 127 and the process chamber 103 is a UV transmissive window 113 made from special fluorinated glass or sapphire. The UV transmissive window 113 is held in place with a window clamp assembly 114 and an O-ring seal 115 which is provided to seal, thereby isolating, the UV chamber 127 from the process chamber 103. The UV transmissive window 113 is thick enough to withstand pressure differences across this window that result from the process chamber 103 and the UV chamber 127 being maintained at different pressures.

Isolating chambers 103 and 127 from one another allows for the process chamber 103 to be simultaneously run at a different pressure than the UV chamber 127. More specifically, during preparation for processing, the process chamber 103 is first run at sub-atmospheric pressures to remove the undesirable gases from the processing environment while backfilling the process chamber 103 with the specific gas composition desired for processing, such as cleaning and/or the surface treatment of photomask, reticle substrates and semiconductor substrates.

A UV power detector 121 is integrated into the mask platen 104 for monitoring the intensity of the UV radiation throughout processing. Alternatively, an integrated UV radiation detection system can be included in the UV chamber 127. A UV power detector 121 is desirable because UV lamps typically have a short lifetime.

The introduction of oxygen gas into the process chamber 103 during processing will produce ozone in proportion to the amount of oxygen present. However ozone is a very strong absorber of the 172 nm wavelength so the concentration of ozone should be closely controlled so that the short wavelength, high energy radiation gets to the surface of the substrate/photo mask 107 where it facilitates the chemical activity. Accordingly, ozone detector 122 is coupled to process chamber 103 to perform such monitoring.

With each new loading of a new substrate/photo mask, the precise process gas composition within the process chamber 103 must be re-established. The sub-atmospheric pressure capabilities of the present invention will provide the capability to do this rapidly to provide a system with high productivity.

The substrate/photo mask support 108 is preferably adjustable in height with respect to the mask platen 104 when in the closed position to position the substrate/photo mask 107 at a pre-determined distances from the UV window 113. Mass flow controllers for nitrogen, oxygen and an auxiliary port for future use (argon) can be provided to allow for a completely inert environment (pure nitrogen or argon environment) for surface treatment applications in addition to the ability to precisely control the oxygen composition for organic removal applications. For cleaning applications the UV source produces ozone and free radical oxygen to oxidize organic contamination on the substrate.

A roughing valve 123 and a vent valve 124 (FIG. 2) with a soft vent to CDA are also operably coupled to process chamber 103. Additionally, a thermocouple vacuum gauge 125 can be provided as illustrated in FIG. 3.

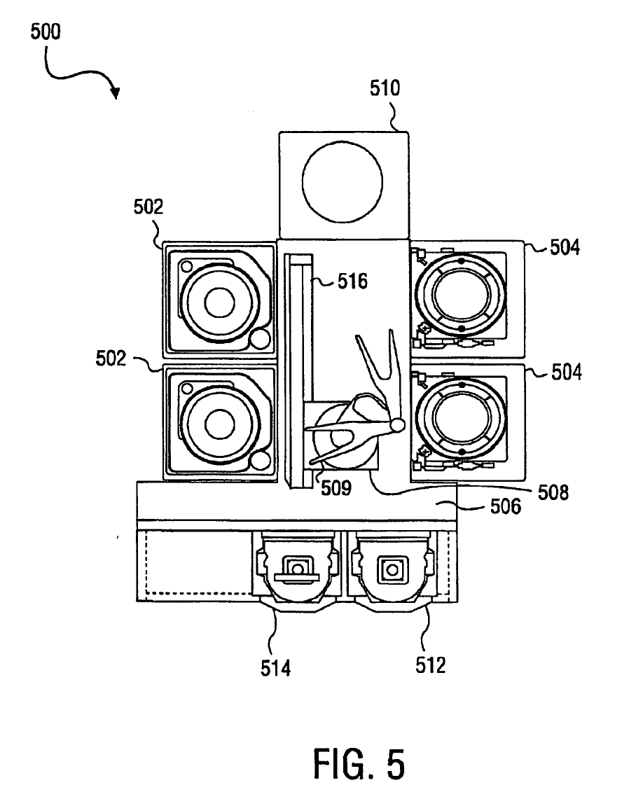

Referring now to FIG. 5, an embodiment of the invention is illustrated wherein a wafer processing apparatus 500 comprises a wet-cleaning chamber 502, a UV drying chamber 504, and a substrate transferring chamber 506 used for processing a substrate such as a wafer. More than one wet-cleaning chamber 502 and more than one UV drying chamber 504 can be included in the apparatus 500 depending throughput requirements. The apparatus 500 can include an inspection chamber 510 which may include tools (not shown) to inspect the substrates that have been processed in the apparatus 500. The tools may include devices that inspect the wafer to see if all of the liquids are removed from the wafer.

The wafer processing apparatus 500 can include a cluster including several single wafer processing chambers, for example, the two wet-cleaning chambers 502, the two UV drying chambers 504, and the substrate transferring chamber 506. The apparatus 500 can also include other positioned about the robot arm assembly 509. The illustrated apparatus 500 also includes a number of wafer cassettes 512 and 514, each holding a plurality of wafers to be cleaned and dried.

In one example, a wafer is processed first in a wet-cleaning chamber 502 for macroscopic cleaning to remove all visibly detectable residues or liquids (e.g., particles and reagents). Then, the wafer is moved to the UV drying chamber 504 to remove the liquids that are not visibly detectable but that are trapped in the voids or pores of the films formed on the wafer. The cleaning processes of the wafer in the apparatus 500 proceeds in a sequence timed to optimize the use of available space and the robot arm assembly 509. One possible sequence for cleaning and drying wafers that has film(s) formed upon it includes: the robot arm assembly 509 take an unclean wafer from a wafer cassette 512, install the wafer into a wet-cleaning chamber 502, remove a clean wafer from another wet-cleaning chamber 502, place this clean wafer into a UV drying chamber 504, and take a dried wafer from another UV drying chamber 504 and place the dried wafer into the wafer cassette 514. This movement from the wafer cassette 512 to one wet-cleaning chamber 502, to a UV drying chamber 504, and so on will optimize wafer cleaning times. Other sequence variations may be used to select an optimal wafer cleaning and drying cycle time.

While the invention has been described and illustrated in sufficient detail that those skilled in this art can readily make and use it, various alternatives, modifications, and improvements should become readily apparent without departing from the spirit and scope of the invention.

What is claimed is:

1. A method for cleaning a substrate comprising cleaning the substrate in a wet-cleaning module; drying the substrate in the wet-cleaning module; transferring the substrate from the wet-cleaning module to a UV module, the UV module having a source of UV radiation; and drying the substrate in the UV module using UV radiation at subatmospheric pressure and at a temperature below 100° C.; wherein the wet-cleaning module and the UV module are coupled to a substrate transferring module which transfers the substrate to and from the wet-cleaning module and the UV module.

2. The method of claim 1 wherein the temperature does not exceed 80° C.

3. The method of claim 1 wherein the substrate includes a low-K dielectric material having pores.

4. The method of claim 1 wherein the substrate includes a low-K dielectric material having pores which have residual liquids and wherein the UV drying of the substrate in the UV module removes the residual liquids in the pores.

5. The method of claim 1 wherein transferring the substrate from the wet-cleaning module to the UV drying module is preformed by a robot included in the substrate transferring module.

6. The method of claim 1 wherein the drying in the UV module is carried out for 60 to 90 seconds.

7. An apparatus for cleaning a substrate comprising a UV module having a source of UV radiation; a wet-cleaning module having drying means; a substrate transferring module having means to transfer a cleaned substrate from the wet-cleaning module to the UV module; means to reduce pressure in the UV module; and a source of UV radiation in the UV module capable of drying the substrate at sub-atmospheric pressure and at a temperature below 100° C.

8. The apparatus of claim 7 wherein the source of UV radiation is a pulse xenon excimer lamp providing incoherent vacuum ultraviolet (VUV) radiation at 172 nm at a temperature not exceeding 80° C. without cooling.

9. The apparatus of claim 7 wherein the UV module comprises a VUV light box having three UV light sources and a reflector which providing incoherent VUV radiation at 172 nm in a nitrogen atmosphere and a VUV processing module having gas distribution manifolds, a vacuum manifold, and sensor ports.

10. The apparatus of claim 7 wherein the means to reduce the pressure can provide subatmospheric pressure below 10 Torr.

11. The apparatus of claim 7 wherein the UV module includes a VUV light box having a UV light source, means for creating an inert gas atmosphere, and a ultraviolet transmissive window separating the light box and the UV module.

12. The apparatus of claim 11 wherein the ultraviolet transmissive window is made of fluorinated glass or sapphire.

13. The apparatus of claim 11 further comprising a reflector for providing uniform ultraviolet radiation transmission.

14. The apparatus of claim 11 comprising a controller that activates the means for creating a cleaning gas atmosphere upon activating the means for reducing pressure, thereby backfilling the first module with cleaning gas as undesirable gases are removed.

15. The apparatus of claim 11 further including a source of inert gas is selected from the group consisting of nitrogen and argon.

16. The apparatus of claim 7 comprising two or more of the UV modules.
